(19) United States
(12) Patent Application Publication
(10) Pub. No.: US 2012/0305553 A1
(43) Pub. Date: Dec. 6, 2012

(54) STACKABLE FLUID STORAGE SYSTEM

(75) Inventors: Arthur Duncan BROTZELL, Calgary (CA); Donalee McColl-Brotzell, Calgary (CA); Kent Roger ANDERSON, Calgary (CA)

(73) Assignee: 1607369 Alberta Ltd., Calgary (CA)

(21) Appl. No.: 13/489,313

(22) Filed: Jun. 5, 2012

Related U.S. Application Data
(60) Provisional application No. 61/493,960, filed on Jun. 6, 2011.

(51) Int. Cl. B65D 90/00; F16J 15/02

(52) U.S. Cl. 220/23.83; 277/642

(57) ABSTRACT

A stackable fluid storage tank and a sealing system for attaching to a pair of fluid containers to provide a stackable fluid storage tank. The stackable fluid storage tank includes first and second fluid containers. When the containers are mated, a first aperture on the first fluid container is in fluid communication with a second aperture on the second fluid container for providing fluid communication between the first and second fluid containers. When the containers are mated, a rigid seal tongue extending from the first fluid container is received within a seal groove defined by the second fluid container for providing a fluid-tight seal between the first and second fluid containers around the first and second apertures.

### CROSS REFERENCE TO RELATED APPLICATIONS

This application claims the benefit of priority of U.S. Provisional Patent Application No. 61/493,960 filed Jun. 6, 2011, which is incorporated herein by reference in its entirety.

### FIELD

The present disclosure relates to fluid storage systems, and more particularly to a stackable fluid storage system.

### BACKGROUND

Some fluid storage systems used in oilfield operations for temporary fluid storage currently utilize interconnected cylindrical tanks. The diameter of the tanks must be narrow enough that when laid on their side on a truck, trailer, or rail car they can be hauled at legal height and width for highway or railway loads to ensure ease of movement and transport between sites. As well, the height of the tanks must be limited so that when stood on end on the storage site the tanks will be stable and unlikely to tip, and when laid on their side on a truck, trailer, or rail car they can be hauled as legal length loads on highways or railways. These limitations of diameter and height effectively restrict the volume of fluid that can be stored in a cylindrical tank, resulting in a standard size tank which is approximately 12 feet in diameter by 20 feet high, and which can hold approximately 400 barrels, or 63 cubic meters of fluid.

Modern hydraulic fracturing treatments used in tight oil and gas formations, particularly shale gas reservoirs, utilize very large volumes of fluids. Thus, the use of standard 400 barrel tanks for temporary fluid storage requires a large footprint and a complex system of interconnected piping and manifolds to connect a large number of tanks to the fluid pumping equipment. This results in the need to plan for a significant amount of space for storing the tanks, and increases the possibility of multiple points of leakage as the number of interconnections grows.

A temporary earthen lagoon with a liner may be used in combination with an array of standard tanks to store water. The water may be pumped to the tanks where the additives required to use the water as a fracturing fluid (“frac fluid”) are added and mixed and from which the treated fluid is transferred to the pumping equipment.

Large diameter cylindrical walled containers with a liner may be open to the atmosphere, leaving a fluid surface area susceptible to contamination, and allowing significant heat loss in cold temperatures. Sites where large fracturing operations are conducted may only be accessible in winter, and thus constant heating of water based fluids is required in the open containers to prevent freezing of the fluid. The large heat loss surface area can significantly increase heating costs, making the oilfield operations significantly more expensive to conduct.

On completion of fracturing operations, the wells must be flowed back and large volumes of the frac fluids must be recovered for temporary storage. Generally, the recovered frac fluids contain chemical additives and may be contaminated by substances produced from the oil and gas reservoirs. Recovered fluids must therefore be flowed back to secure storage and cannot be allowed to escape to the environment. Thus, storage systems used for storing the recovered frac fluids must be able to safely withstand the encountered flow rates and pressures.

It may be undesirable to flow back frac fluid into open fluid storage systems. As well, if frac fluids are recovered to closed tank systems, it may be necessary to clean the tanks of contaminants before they can be used again to store clean frac fluid for a subsequent operation. Standard 400 barrel tanks are difficult to clean, particularly if contaminated with solids or sludge-like materials, which is not uncommon. Cleaning sometimes requires persons to enter the tank through a manway and physically remove the solid or sludge materials.

What is needed is an improved fluid storage system which overcomes at least some of the drawbacks and limitations as described above.

### SUMMARY

The present disclosure relates to a fluid storage system, and more particularly to a stackable fluid storage system.

In a first aspect, the present disclosure provides a stackable fluid storage tank and a sealing system for attaching to a pair of fluid containers to provide a stackable fluid storage tank. The stackable fluid storage tank includes first and second fluid containers. When the containers are mated, a first aperture on the first fluid container is in fluid communication with a second aperture on the second fluid container for providing fluid communication between the first and second fluid containers. When the containers are mated, a rigid seal tongue extending from the first fluid container is received within a seal groove defined by the second fluid container for providing a fluid-tight seal between the first and second fluid containers around the first and second apertures.

In a further aspect, the present disclosure provides a stackable fluid storage tank including a top tank component having an opening with a top seal piece along an edge of the opening in the top tank component, and a bottom tank component having an opening with a bottom seal piece along an edge of the opening in the bottom tank component. The top tank component and the bottom tank component are stackable such that the top seal piece and the bottom seal piece are mated to provide a fluid seal between the top and bottom tank components. When stacked, the openings provide fluid communication between the top tank component and the bottom tank component. Fluid may be stored in the stacked top and bottom tank components.

Illustrative non-limiting examples of uses for the stackable fluid storage tank include:

(i) Temporary storage of frac fluids for hydraulic fracturing operations in oil and natural gas wells;

(ii) Flow back of frac fluids for disposal or for cleaning and re-use;

(iii) Temporary storage of potable water in emergency or natural disaster situations.

In a further aspect, a two-part stackable fluid storage tank is provided in which an upper tank component is stackable on top of a lower tank component. The upper tank component and the lower tank component of the fluid storage tank each have an opening configured to be mated and sealed when the upper tank component is placed on top of the lower tank component. After stacking, the upper tank component and the lower tank component of the fluid storage tank are in fluid communication via their respective openings, and the fluid seal formed at the mated openings prevents any leakage of fluid along the mated edges of the upper tank component and the lower tank component of the stackable fluid storage tank. A seal design uses the weight of the upper tank component of the storage tank to provide a wedge effect to provide a secure fluid seal. In an embodiment, the seal may be further secured by buckling or clamping the upper tank component and lower tank component together after the two components have been stacked.

In a further aspect, the present disclosure provides a stackable fluid storage tank including a first fluid container and a second fluid container. The first fluid container includes a first body for containing fluid, a first aperture defined by the first body, the first aperture providing fluid communication with an interior of the first body, first seal component extending from the first body around the first aperture, and a first rigid seal tongue extending from the first seal component. The second fluid container includes a second body for containing fluid, a second aperture defined by the second body, the second aperture providing fluid communication with an interior of the second body, a second seal component extending from the second body around the second aperture, and a first seal groove defined by the second seal component and extending along the second seal component. The first aperture is in fluid communication with the second aperture when the first fluid container is mated with the second fluid container for providing fluid communication between the first and second fluid containers. The first rigid seal tongue is sized to be received within the first seal groove for providing a fluid-tight seal between the first and second fluid containers around the first and second apertures when the first fluid container is mated with the second fluid container.

In an embodiment, the first rigid seal tongue has a first cross-section in the shape of a first trapezoid, the first cross-section having a first wide base proximate the first body, a first narrow base distal the first body, and a pair of first legs between the first wide base and the first narrow base. The first seal groove has a second cross-section in the shape of a second trapezoid, the second cross-section having a second narrow base proximate the second body, a second wide base distal the second body, the second wide base defining a mouth of the first seal groove, and a pair of second legs between the second narrow base and the second wide base. In an embodiment, the first trapezoid is a first isosceles trapezoid and each of the first legs forms a first angle with the first narrow base, and wherein the second trapezoid is a second isosceles trapezoid and each of the second legs forms a second angle with the second narrow base. In an embodiment, the first angle is larger than the second angle to facilitate providing the fluid-tight seal. In an embodiment, the first angle is larger than the second angle by between about 1 degree and about 5 degrees. In an embodiment, the first angle is between about 116 degrees and about 125 degrees, and the second angle is between about 115 degrees and about 120 degrees.

In an embodiment, the first rigid seal tongue has a first cross-section in the shape of a first trapezoid, the first cross-section having a first wide base proximate the first body, a first narrow base distal the first body, and a pair of first legs between the first wide base and the first narrow base. The first seal groove has a second cross-section in the shape of a second trapezoid, the second cross-section having a second narrow base proximate the second body, a second wide base distal the second body, the second wide base defining a mouth of the first seal groove, and a pair of second legs between the second narrow base and the second wide base. In an embodiment, the first trapezoid is a first isosceles trapezoid and each of the first legs forms a first angle with the first narrow base, and wherein the second trapezoid is a second isosceles trapezoid and each of the second legs forms a second angle with the second narrow base. In an embodiment, the first angle is smaller than the second angle. In an embodiment, the first angle is smaller than the second angle by between about 1 degree and about 5 degrees. In an embodiment, the first angle is between about 110 degrees and about 119 degrees, and the second angle is between about 115 degrees and about 120 degrees.

In an embodiment, the first rigid seal tongue has a first cross-section in the shape of a first trapezoid, the first cross-section having a first wide base proximate the first body, a first narrow base distal the first body, and a pair of first legs between the first wide base and the first narrow base. The first seal groove has a second cross-section in the shape of a second trapezoid, the second cross-section having a second narrow base proximate the second body, a second wide base distal the second body, the second wide base defining a mouth of the first seal groove, and a pair of second legs between the second narrow base and the second wide base. In an embodiment, the first trapezoid is a first isosceles trapezoid and each of the first legs forms a first angle with the first narrow base, and wherein the second trapezoid is a second isosceles trapezoid and each of the second legs forms a second angle with the second narrow base. In an embodiment, the first angle is substantially equal to the second angle and the first narrow base, first legs, second narrow base, and second legs are sized to facilitate complete nesting of the first rigid seal tongue in the first seal groove.

In an embodiment, the stackable fluid storage tank includes a third fluid container. The third fluid container includes a third body for containing fluid, a third aperture defined by the third body, the third aperture providing fluid communication with an interior of the third body, a third seal component extending from the third body around the third aperture, and a second rigid seal tongue extending from the third seal component. The first fluid container includes a fourth aperture defined by the first body and opposed from the first aperture, the fourth aperture providing fluid communication with the interior of the first body, a fourth seal component extending from the first body around the fourth aperture, and a second seal groove defined by the fourth seal component and extending along the fourth seal component. The fourth aperture is in fluid communication with the third aperture when the first fluid container is mated with the third fluid container for providing fluid communication between the first and third fluid containers. The second rigid seal tongue is sized to be received within the second seal groove for providing a fluid-tight seal between the first and third fluid containers around the fourth and third apertures when the first fluid container is mated with the third fluid container.

In an embodiment, the stackable fluid storage tank includes a third fluid container. The third fluid container includes a third body for containing fluid, a third aperture defined by the third body, the third aperture providing fluid communication with an interior of the third body, a third seal component extending from the third body around the third aperture, and a second seal groove defined by the third seal component and extending along the third seal component. The first fluid container includes a fourth aperture defined by the first body and opposed from the first aperture, the fourth aperture providing fluid communication with the interior of the first body, a fourth seal component extending from the first body around the fourth aperture, and a second rigid seal tongue extending from the fourth seal component. The fourth aperture is in fluid communication with the third aperture when the first fluid container is mated with the third fluid container for providing fluid communication between the first and third fluid containers. The second rigid seal tongue is sized to be received within the second seal groove for providing a fluid-tight seal between the first and third fluid containers around the fourth and third apertures when the first fluid container is mated with the third fluid container.

In an embodiment, the stackable fluid storage tank includes a third fluid container. The third fluid container includes a third body for containing fluid, a third aperture defined by the third body, the third aperture providing fluid communication with an interior of the third body, a third seal component extending from the third body around the third aperture, and a second rigid seal tongue extending from the third seal component. The second fluid container includes a fourth aperture defined by the second body and opposed from the second aperture, the fourth aperture providing fluid communication with the interior of the second body, a fourth seal component extending from the second body around the fourth aperture, and a second seal groove defined by the fourth seal component and extending along the fourth seal component. The fourth aperture is in fluid communication with the third aperture when the second fluid container is mated with the third fluid container for providing fluid communication between the second and third fluid containers. The second rigid seal tongue is sized to be received within the second seal groove for providing a fluid-tight seal between the second and third fluid containers around the fourth and third apertures when the second fluid container is mated with the third fluid container.

In an embodiment, the first aperture is substantially the entire area of a first face of the first tank and the second aperture is substantially the entire area of a second face of the second tank.

In an embodiment, the first fluid container is substantially coextensive with the second fluid container when the first fluid container is mated with the second fluid container.

In an embodiment, the fluid-tight seal is a metal-to-metal seal.

In an embodiment, the stackable fluid storage tank includes retainers for retaining the first and second tank components in place when the first and second tank components are mated.

In an embodiment, the stackable fluid storage tank includes a first hinge component extending from the first body and a second hinge component extending from the second body, the first and second hinge components combining as a hinge between the first and second fluid containers when the first and second fluid tanks are mated.

In a further aspect, the present disclosure provides a sealing system for providing a fluid-tight seal between a pair of fluid containers. The sealing system includes a first elongate member defining a first elongate attachment surface and an opposed first elongate seal surface, the first elongate member including a first seal component extending from the first elongate seal surface and a rigid seal tongue extending from the first seal component, wherein the rigid seal tongue has a first cross-section in the shape of a first trapezoid, the first cross-section having a first wide base proximate the first elongate seal surface, a first narrow base distal the first elongate seal surface, and a pair of first legs between the first wide base and the first narrow base. The sealing system includes a second elongate member defining a second attachment surface and an opposed second seal surface, the second elongate member including a second seal component extending from the second seal surface, the second seal component defining a seal groove extending along the second seal component, wherein the seal groove has a second cross-section in the shape of a second trapezoid, the second cross-section having a second narrow base proximate the second seal surface, a second wide base distal the second seal surface, the second wide base defining a mouth of the seal groove, and a pair of second legs between the second narrow base and the second wide base. The first and second attachment surfaces are for attaching to the fluid containers. The rigid seal tongue is sized to be received within the seal groove for providing a fluid-tight seal between the fluid containers when the first and second elongate members are attached to the fluid containers and when the fluid containers are mated with each other.

In an embodiment, the first trapezoid is a first isosceles trapezoid and each of the first legs forms a first angle with the first narrow base, and wherein the second trapezoid is a second isosceles trapezoid and each of the second legs forms a second angle with the second narrow base. In an embodiment, the first angle is larger than the second angle to facilitate providing the fluid-tight seal. In an embodiment, the first angle is larger than the second angle by between about 1 degree and about 5 degrees. In an embodiment, the first angle is between about 116 degrees and about 125 degrees, and the second angle is between about 115 degrees and about 120 degrees.

In an embodiment, the first trapezoid is a first isosceles trapezoid and each of the first legs forms a first angle with the first narrow base, and wherein the second trapezoid is a second isosceles trapezoid and each of the second legs forms a second angle with the second narrow base. In an embodiment, the first angle is smaller than the second angle. In an embodiment, the first angle is smaller than the second angle by between about 1 degree and about 5 degrees. In an embodiment, the first angle is between about 110 degrees and about 119 degrees, and the second angle is between about 115 degrees and about 120 degrees.

In a further aspect, the present disclosure provides a stackable fluid storage tank including a first fluid container and a second fluid container. The first fluid container includes a first body for containing fluid, a first aperture defined by the first body, the first aperture providing fluid communication with an interior of the first body, a first seal component extending from the first body around the first aperture, and a rigid seal tongue extending from the first seal component. The rigid seal tongue has a first cross-section in the shape of a first trapezoid, the first cross-section having a first wide base proximate the first body, a first narrow base distal the first body, and a pair of first legs between the first wide base and the first narrow base, each of the first legs forming a first angle with the first narrow base. The second fluid container includes a second body for containing fluid, a second aperture defined by the second body, the second aperture providing fluid communication with an interior of the second body, a second seal component extending from the second body around the second aperture, and a seal groove defined by the second seal component and extending along the second seal component. The seal groove has a second cross-section in the shape of a second trapezoid, the second cross-section having a second narrow base proximate the second body, a second wide base distal the second body, the second wide base defining a mouth of the seal groove, and a pair of second legs between the second narrow base and the second wide base, each of the second legs forming a second angle with the second narrow base. The first aperture is substantially coextensive with the second aperture when the first fluid container is mated with the second fluid container for providing fluid communication between the first and second fluid containers. The rigid seal tongue is sized to be received within the seal groove for providing a fluid-tight seal between the first and second fluid containers around the first and second apertures when the first fluid container is mated with the second fluid container. The first angle is larger than the second angle to facilitate providing the fluid-tight seal.

In an embodiment, the first angle is larger than the second angle by between about 1 degree and about 5 degrees. In an embodiment, the first angle is between about 116 degrees and about 125 degrees, and the second angle is between about 115 degrees and about 120 degrees.

In an embodiment, the first aperture is substantially the entire area of a first face of the first tank and the second aperture is substantially the entire area of a second face of the second tank.

### BRIEF DESCRIPTION OF THE DRAWINGS

FIG. 1 is a perspective view of a stackable fluid storage tank where a first fluid container is separated from a second fluid container;

FIG. 2 is a perspective view of the stackable fluid storage tank of FIG. 1 where the first fluid container is mated with the second fluid container;

FIG. 3 is a cross-sectional elevation view of sealing components of the first and second fluid containers of FIG. 1 where the first fluid container is separated from a second fluid container;

FIG. 4 is a cross-sectional elevation view of a the sealing components of FIG. 3 forming a seal between the first and second fluid containers of FIG. 1;

FIG. 5 is a cross-sectional elevation view of sealing components of the first and second fluid containers of FIG. 1 where the first fluid container is separated from a second fluid container;

FIG. 6 is a cross-sectional elevation view of the sealing components of FIG. 5 forming a seal between the first and second fluid containers of FIG. 1;

FIG. 7 is a perspective view of a stackable fluid storage tank where a first fluid container, a second fluid container, and a third fluid container are separated from each other;

FIG. 8 is a perspective view of a stackable fluid storage tank where a first fluid container, a second fluid container, and a third fluid container are separated from each other;

FIG. 9 is a perspective view of a stackable fluid storage tank where a first fluid container is separated from a second fluid container;

FIG. 10 is a perspective view of the stackable fluid storage tank of FIG. 8 where the first fluid container is mated with the second fluid container;

FIG. 11 is a perspective view of the stackable fluid storage tank of FIG. 1 where the first fluid container retained with the second fluid container by retainers; and

FIG. 12 is a perspective view of wall stiffeners for strengthening a wall of the stackable fluid storage tank of FIG. 1.

### DETAILED DESCRIPTION

The present disclosure relates to fluid storage systems, and more particularly to a stackable fluid storage tank.

Stackable Fluid Storage Tank

A stackable fluid storage tank is provided herein which overcomes at least some of the drawbacks and limitations described above.

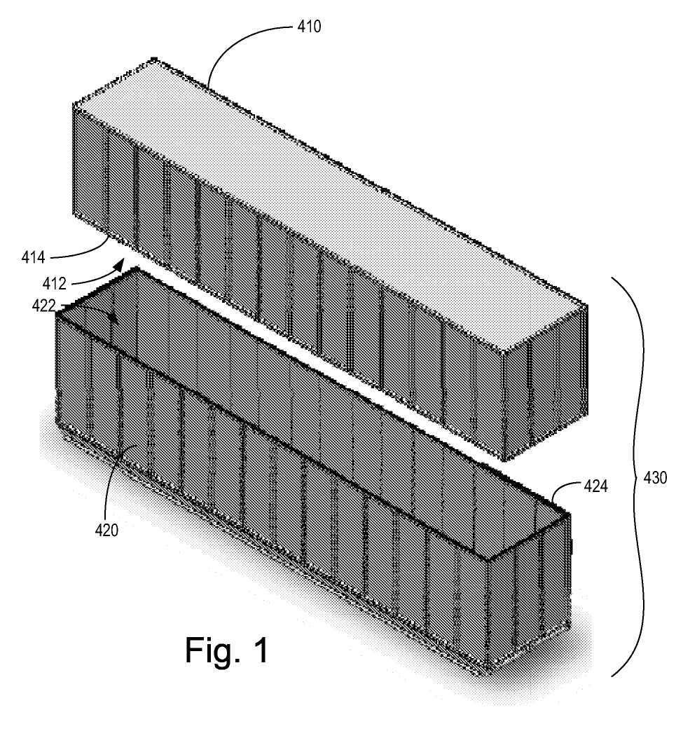

FIG. 1 is a perspective view of a stackable fluid storage tank 430 in accordance with an embodiment, wherein a first fluid container 410 is separated from a second fluid container 420.

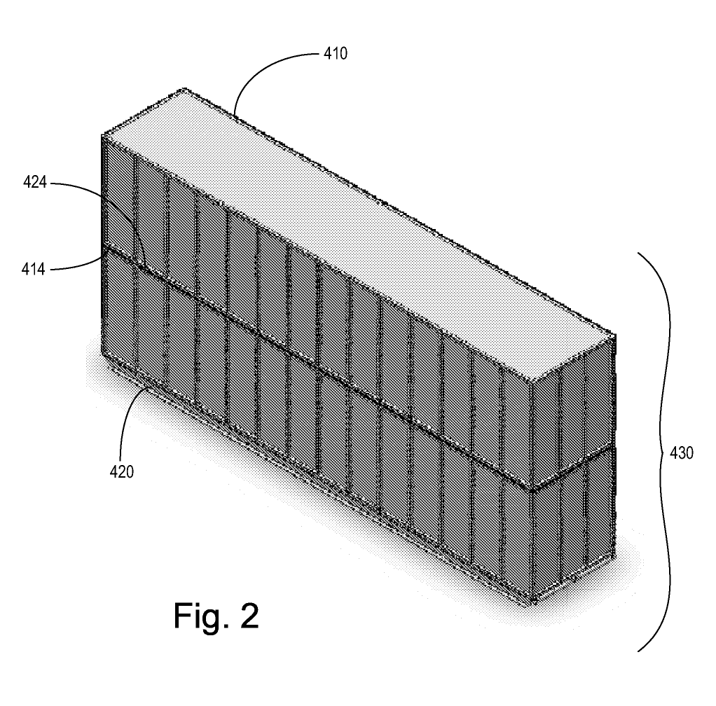

FIG. 2 is a perspective view of the stackable fluid storage tank 430 wherein the first fluid container 410 is mated with the second fluid container 420.

The first fluid container 410 defines a first aperture 412 on one face of the first fluid container 410. The second fluid container 420 defines a second aperture 422 on one face of the second fluid container 420. A first edge 414 defines a perimeter around the first aperture 412. A second edge 424 defines a perimeter around the second aperture 422. The first fluid container 410 and the second fluid container 420 are configured to mate at their respective apertures 412, 422, providing fluid communication between the first and second fluid containers 410, 420. The first and second fluid containers 410, 420 include seal components to provide a fluid-tight seal between the first and second fluid containers 410, 420 (see below). The fluid-tight seal prevents leakage along the mated first and second edges 414, 424. The first and second edges 414, 424 are sufficiently rigid to facilitate providing a stable fluid-tight seal where the stackable fluid storage tank 430 is on uneven terrain. The stackable fluid storage tank 430 has the combined capacity of the first fluid container 410 and the second fluid container 420, and is sealed to prevent leakage of fluid.

In an embodiment, the potential for contamination of fluid within the stackable fluid storage tank 430 by material from outside the stackable fluid storage tank 430 may be mitigated by the lack of apertures providing fluid communication into the stackable fluid storage tank 430 from outside.

Seal

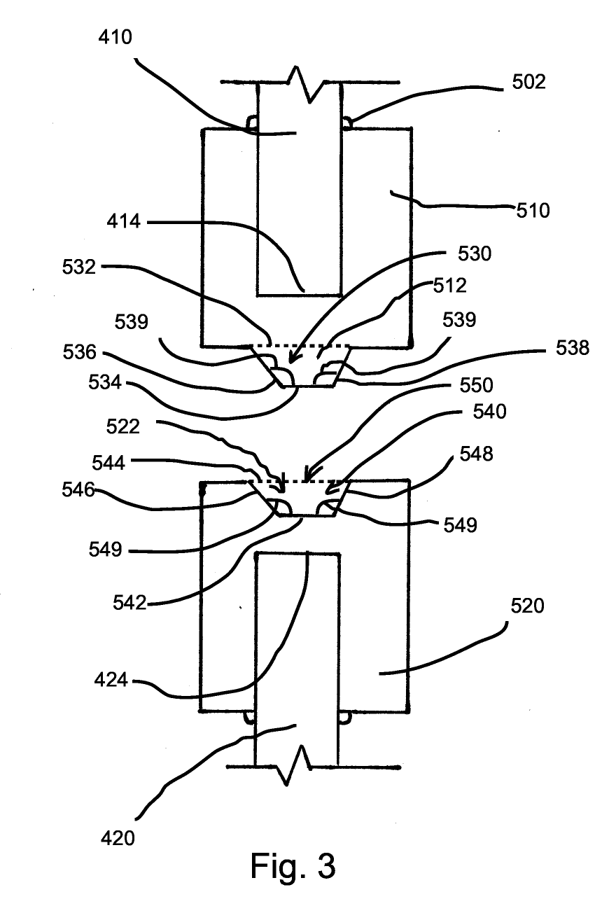

FIG. 3 is a cross-sectional elevation view of sealing components of the first and second fluid containers 410, 420 where the first fluid container 410 is separated from the second fluid container 420.

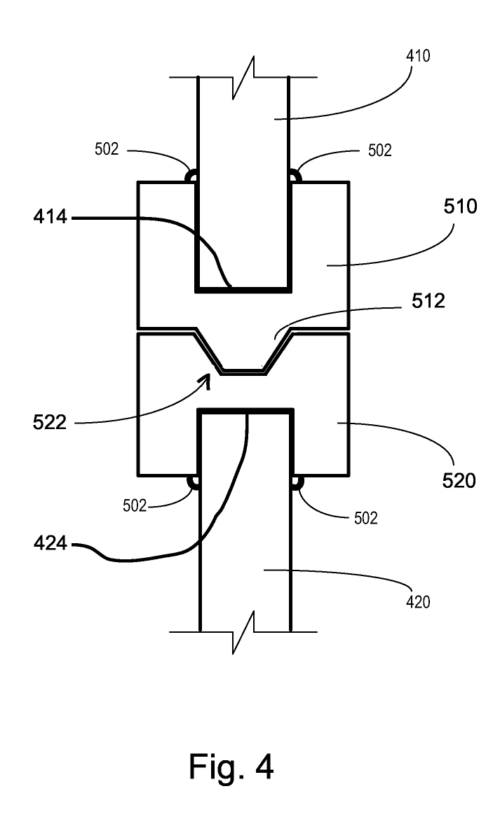

FIG. 4 is a cross-sectional elevation view of a fluid-tight seal formed between the first and second fluid containers 410, 420.

A first seal component 510 extends from the first edge 414. A second seal component 520 extends from the second edge 424. A rigid seal tongue 512 extends from the first seal component 510. A seal groove 522 is defined in the second seal component 520. The rigid seal tongue 512 is sized to be received within the seal groove 522 for providing the fluid-tight seal between the first and second fluid containers 410, 420 around the first and second apertures 412, 422 when the first and second fluid containers 410, 420 are mated.

In an embodiment, the rigid seal tongue 512 has a first cross-section 530 in the shape of a first trapezoid and the seal groove 522 has a second cross-section 540 in the shape of a second trapezoid. The first cross-section 530 has a first wide base 532 proximate the first edge 414, a first narrow base 534 distal the first edge 414, and a pair of first legs 536, 538 between the first wide base 532 and the first narrow base 534. The second cross-section 540 has a second narrow base 542 proximate the second edge 424, a second wide base 544 distal the second edge 424, the second wide base 544 defining a mouth 550 of the seal groove 522, and a pair of second legs 546, 548 between the second narrow base 542 and the second wide base 544. The first cross-section 530 provides a wedge shape with a flat nose (at the first narrow base 534) to the rigid seal extension 512. The second cross-section 540 provides a wedge shape with a flat nose (at the second narrow base 542) to the seal groove 522.

In an embodiment, the first and second seal components 510, 520 may extend longitudinally along the first and second edges 414, 424. In an embodiment, the seal pieces may be welded 502 to the first and second fluid containers 410, 420 longitudinally along the first and second edges 414, 424. When the first and second fluid containers 410, 420 are mated, the weight of whichever of the first and second fluid containers 410, 420 is on top may facilitate providing the fluid-tight seal by the seal pieces 510, 520 along the first and second edges 414, 424.

Alternatively, the first and second seal components 510, 520 may be reversed relative to their positions in FIGS. 3 and 4, such that the second seal component 520 is on top of the first seal component 510. In this alternative embodiment, the wedge-shape of the first seal component 510 may reduce or eliminate dirt particles or other contaminants from being trapped between the first and second seal components 510, 520 as the first fluid container 410 is stacked on top of second fluid container 420.

In an embodiment, the dimensions of the first and second seal components 510, 520 are manufactured to precise dimensions that are continuous along the respective lengths of each of the first and second seal components 510, 520. The dimensions of the first narrow base 534 and second narrow base 542 may be manufactured to facilitate a precision fit between the rigid seal tongue 512 and the seal groove 522.

In an embodiment, the first and second cross-sections 530, 540 are in the shape of a first isosceles trapezoid and a second isosceles trapezoid, respectively. Each of the first legs 536, 538 forms a first angle 539 with the first narrow base 534. Each of the second legs 546, 548 forms a second angle 549 with the second narrow base 542.

In an embodiment, the first angle 539 is substantially equal to the second angle 549 and the first narrow base 534, first legs 536, 538, second narrow base 542, and second legs 546, 548 are sized to facilitate complete nesting of the rigid seal tongue 512 in the seal groove 522.

In an embodiment, the first angle 539 is larger than the second angle 549, to impart a wedge effect, facilitating providing a fluid-tight seal between the first and second seal components 510, 520. The fluid-tight seal may be present along the respective surfaces of the first and second narrow bases 534, 542, the first legs 536, 538, and the second legs 546, 548.

In an embodiment, the first angle 539 is larger than the second angle 549 by between about 1 degree and about 5 degrees. In an embodiment, the first angle 539 is between about 116 degrees and about 125 degrees, and the second angle 549 is between about 115 degrees and about 120 degrees.

In an embodiment, the first angle 539 is smaller than the second angle 549. In an embodiment, the first angle 539 is smaller than the second angle 549 by between about 1 degree and about 5 degrees. In an embodiment, the first angle 539 is between about 110 degrees and about 119 degrees, and the second angle 549 is between about 115 degrees and about 120 degrees.

In an embodiment, the first angle 539 is between about 110 and about 115 degrees, and the second angle 549 is between about 105 degrees and about 120 degrees.

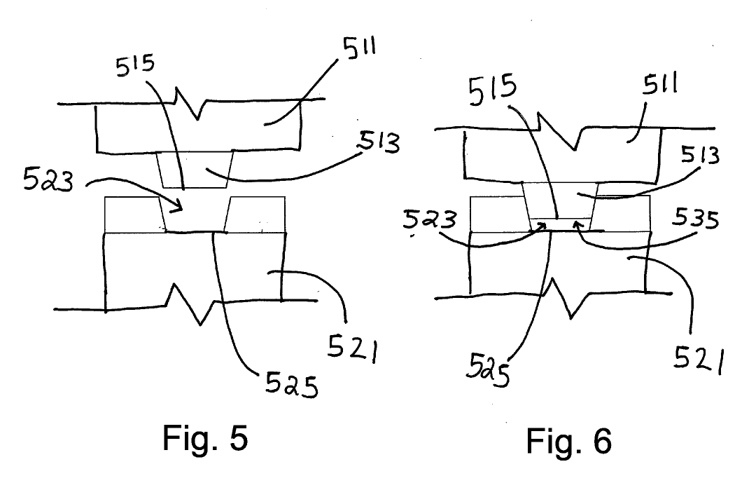

FIG. 5 is a cross-sectional elevation view of an embodiment of a first seal component 511 and a second seal component 521, of the first and second fluid containers 410, 420, respectively, where the first fluid container 410 is separated from the second fluid container 420.

FIG. 6 is a cross-sectional elevation view of a fluid-tight seal formed by the first and second sealing components 511, 521 between the first and second fluid containers 410, 420.

A rigid seal tongue 513 extends from the first seal component 511. A seal groove 523 is defined in the second seal component 521. The rigid seal tongue 513 is sized to be received within the seal groove 523 for providing the fluid-tight seal between the first and second fluid containers 410, 420 around the first and second apertures 412, 422 when the first and second fluid containers 410, 420 are mated. The rigid seal tongue 513 and the seal groove 523 are sized such that when the rigid seal tongue 513 is received within the seal groove 523 for providing the fluid-tight seal, a space 535 remains between a first nose 515 of the rigid seal tongue 513 and a second nose 525 of the seal groove 523.

Operation

In use, one of the first fluid container 410 or the second fluid container 420 may be stacked on top of the other to mate the first and second fluid containers 410, 420. In FIGS. 1 and 2, the first fluid container 410 is stacked on top of the second fluid container 420, and this example is described below. However, the second fluid container 420 may alternatively be stacked on top of the first fluid container 410.

The second fluid container 420 may be placed on a site where fluid storage is required with the second aperture 422 facing up. If the terrain at the site is uneven, the terrain may be leveled. In an embodiment, the second fluid container 420 may be provided with a base or platform with one or more leveling mechanisms attached beneath or around the second fluid container 420. Alternatively, leveling shims may be placed beneath the second fluid container 420 or the location substantially leveled prior to setting the second fluid container 420 in place.

Once the second fluid container 420 is sufficiently level, the first fluid container 410 may be stacked on top of the second fluid container 420 with the first aperture 412 facing down, mating the first and second fluid containers 410, 420. Stacking one of the first and second fluid containers 410, 420 on top of the other generally requires only a picker truck or other lifting apparatus to lift whichever of the first and second fluid containers 410, 420 is to be located on top. When the first and second fluid containers 410, 420 are mated, the first aperture 412 is in fluid communication with the second aperture 422 and the rigid seal tongue 512 is received within the seal groove 522, providing the fluid-tight seal.

In an embodiment where recovered fluids are to be reused, a fluid filtration system may be used to filter recovered fluids. A number of clean stackable fluid storage tanks 430 may be used to store filtered fluids, and empty stackable fluid storage tanks 430 may be cleaned and subsequently used to receive filtered fluid from another stackable fluid storage tank 430.

In an embodiment, external faces of the stackable fluid storage tank 430 may be covered with an insulating material to reduce heat loss, for example during cold-weather use.

Additional Fluid Containers

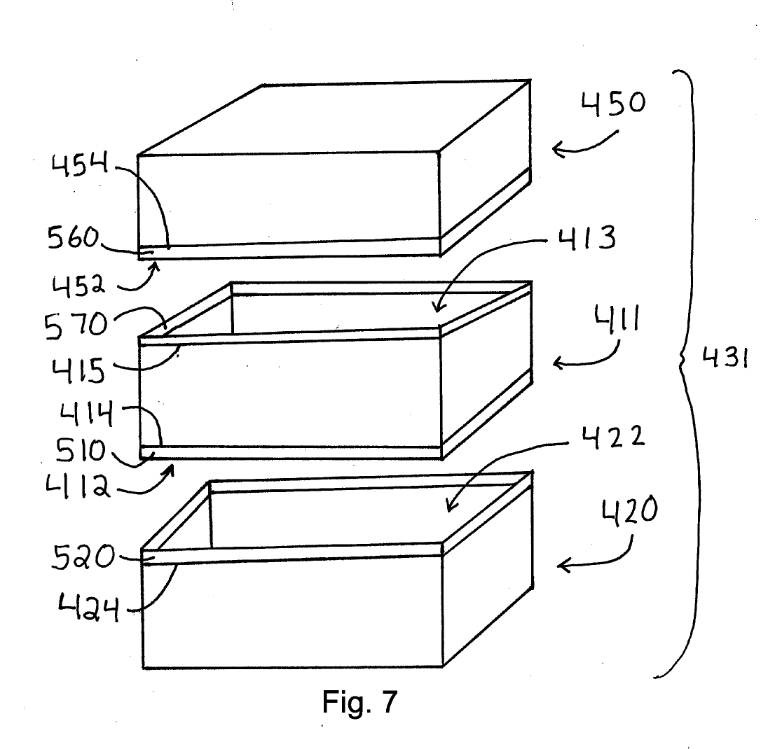

FIG. 7 is a perspective view of a stackable fluid storage tank 431 where a first fluid container 411, the second fluid container 420, and a third fluid container 450 are separated from each other. The third fluid container 450 defines a third aperture 452 on one face of the third fluid container 450. The first fluid container 411 defines a fourth aperture 413 on one face of the first fluid container 411. The fourth aperture 413 is opposed from the first aperture 412. A third edge 454 defines a perimeter around the third aperture 452. A fourth edge 415 defines a perimeter around the fourth aperture 413. The first fluid container 411 and the third fluid container 450 are configured to mate at their respective apertures 413, 452, providing fluid communication between the first and third fluid containers 411, 450. A third seal component 560 extends from the third edge 454, and a fourth seal component 570 extends from the fourth edge 415. The third and fourth seal components 560, 570 provide a fluid-tight seal between the first and third fluid containers 411, 450. The fluid-tight seal prevents leakage along the mated third and fourth edges 454, 415.

Assembly of the stackable fluid storage tank 431 from the first, second, and third fluid containers 411, 420, and 450 facilitates provision of a stackable fluid storage tank with a greater volume than the stackable fluid storage tank 430 prepared from the first and second fluid containers 410, 420 only. Alternatively, the stackable fluid storage tank 431 may have a similar or smaller volume than the stackable fluid storage tank 430, but be assembled from fluid containers that are smaller than the fluid containers used to assemble the stackable fluid storage tank 430, facilitating assembly of the stackable fluid storage tank 431. Additional fluid containers may similarly be used between any of the first, second, or third fluid containers 411, 420, or 450 to facilitate provision of a stackable fluid storage tank with a further increased volume or smaller fluid container size.

In an embodiment, the third seal component 560 includes a rigid seal tongue and the fourth seal component 570 includes a seal groove sized to receive the rigid seal tongue of the third seal component 560, for providing the fluid-tight seal between the first and third fluid containers 411, 450 around the third and fourth apertures 413, 452 when the first and third fluid containers 411, 450 are mated.

In an embodiment, the third seal component 560 includes a seal groove and the fourth seal component 570 includes a rigid seal tongue sized to be received within the seal groove of the third seal component 560, for providing the fluid-tight seal between the first and third fluid containers 411, 450 around the third and fourth apertures 413, 452 when the first and third fluid containers 411, 450 are mated.

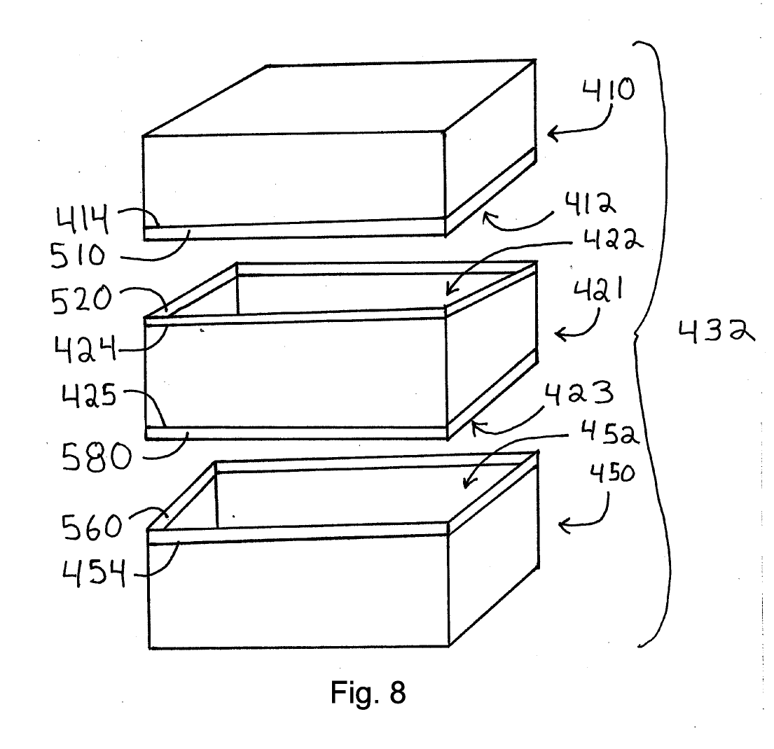

FIG. 8 is a perspective view of a stackable fluid storage tank 432 where the first fluid container 410, a second fluid container 421, and the third fluid container 450 are separated from each other. In an embodiment, the second fluid container 421 defines a fourth aperture 423 on one face of the second fluid container 421. A fourth edge 425 defines a perimeter around the fourth aperture 423. The fourth aperture 423 is opposed from the second aperture 422. The second fluid container 421 and the third fluid container 450 are configured to mate at their respective apertures 423, 452, providing fluid communication between the second and third fluid containers 421, 450. A fourth seal component 580 extends from the fourth edge 425. The third and fourth seal components 560, 580 provide a fluid-tight seal between the second and third fluid containers 421, 450. The fluid-tight seal prevents leakage along the mated third and fourth edges 454, 425.

In an embodiment, the third seal component 560 includes a rigid seal tongue and the fourth seal component 580 includes a seal groove sized to receive the rigid seal tongue of the third seal component 560, for providing the fluid-tight seal between the second and third fluid containers 421, 450 around the third and fourth apertures 423, 452 when the first and third fluid containers 421, 450 are mated.

Hinge

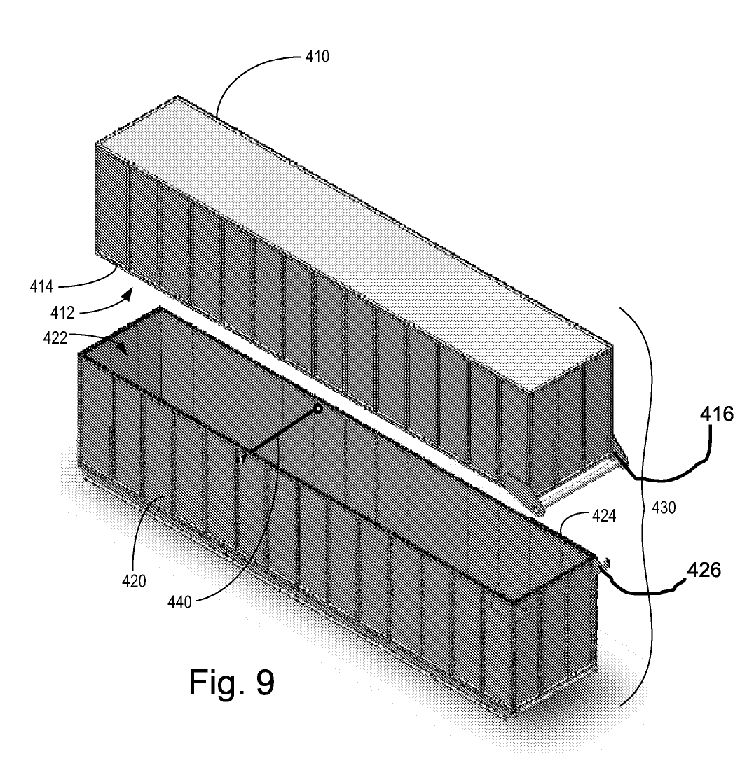

FIG. 9 is a perspective view of the stackable fluid storage tank 430 wherein the first fluid container 410 is separated from the second fluid container 420 and wherein a first hinge component 416 extends from the first fluid container 410 and a second hinge component 426 extends from the second fluid container 420.

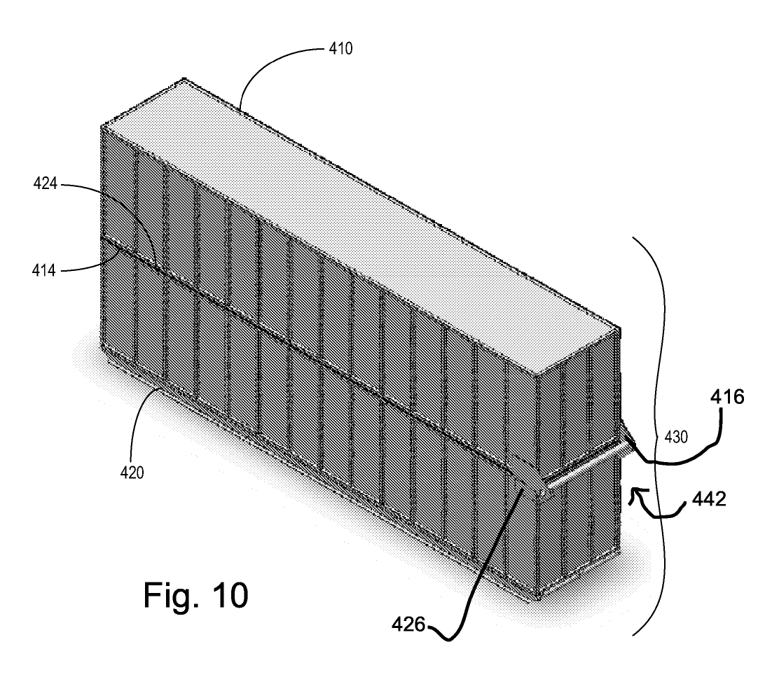

FIG. 10 is a perspective view of the stackable fluid storage tank 430 wherein the first fluid container 410 is mated with the second fluid container 420, and the first and second hinge components 416, 426 are combined as a hinge 442 along one side of the stackable fluid storage tank 430.

The hinge 442 facilitates stacking of the first and second fluid containers 410, 420 by allowing rotation of the first fluid container 410 about the hinge 442 and on top of the second fluid container 420. This method of stacking is alternative to placing first fluid container 410 on top of the second fluid container 420 by aligning the first and second fluid containers 410, 420, without the hinge 442. The hinge 442 facilitates alignment of the first and second fluid containers 410, 420 on all sides, including sides other than the side with the hinge 442.

Retainers

The fluid-tight seal between the first seal component 510 and the second seal component 520 may be further secured by retaining the first and second fluid containers 410, 420 together, for example by buckling or clamping.

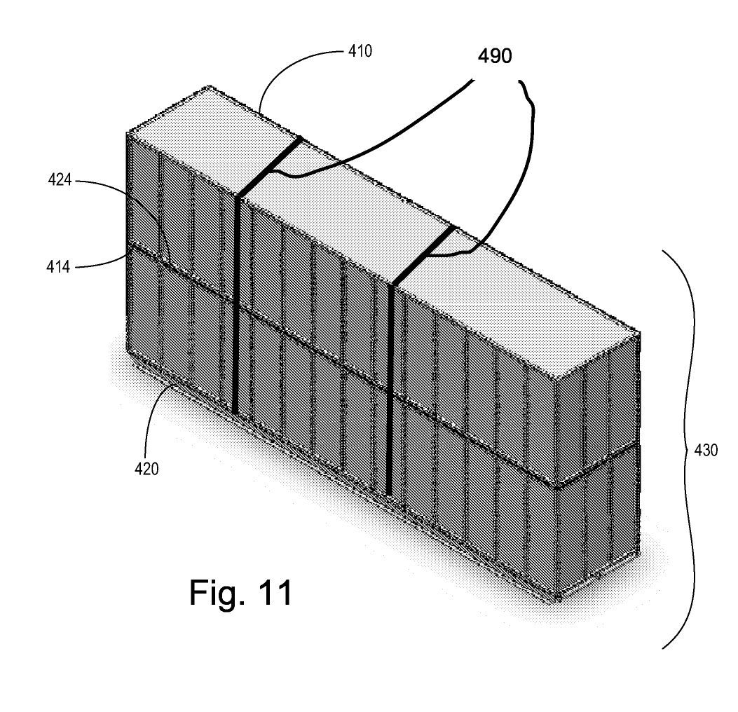

FIG. 11 is a perspective view of the stackable fluid storage tank of 430 wherein the first fluid container 410 retained with the second fluid container 420 by retainers 490 to facilitate formation of the fluid-tight seal. In an embodiment, a plurality of retainers 490 may be spaced around the perimeter of the stackable fluid storage tank of 430 to force the first and second fluid containers 410, 420 together. The retainers 490 may for example be buckling or clamping components.

The retainers 490 may facilitate storage of pressurized fluids (for example back-flowed frac fluids) if approved by regulation in the stackable fluid storage tank 430. The retainers facilitate keeping the first and second fluid containers 410, 420 in a mated relationship where the contents of the stackable fluid storage tank 430 are under pressure.

In an embodiment, each of the retainers 490 may surround the stackable fluid storage tank of 430 from top to bottom (as in FIG. 11).

In an embodiment, each of the retainers 490 may surround the stackable fluid storage tank of 430 at the interface between the first and second edges 414, 424, without surrounding the stackable fluid storage tank of 430 from top to bottom.

Apertures

The first and second apertures 412, 422 of FIGS. 1 and 2 have an open area that is substantially equal to the entire faces of the first and second fluid containers 410, 420 upon which the first and second apertures 412, 422 are respectively located. The stackable fluid storage tank 430 can be accessed by separating the first and second fluid containers 410, 420 from each other. Access to the first and second fluid containers 410, 420 (for example by cleaning equipment such as high-pressure steaming or pressure-washing equipment) to the first and second fluid containers 410, 420 is facilitated where the first and second apertures 412, 422 are sufficiently large to accommodate the cleaning equipment. Where the first and second apertures 412, 422 are sufficiently large to accommodate the cleaning equipment and personnel, the “confined space” safety hazard of a person entering a small manway to clean a standard 400 barrel tank is mitigated.

In another embodiment, rather than being located along all faces of the first and second fluid containers 410, 420, the first and second edges 414, 424 may be located around first and second apertures 412, 422 that have a smaller open area than the entire faces of the first and second fluid containers 410, 420 upon which the first and second apertures 412, 422 are located. For example, the second fluid container 420 may have a partially-covered top with a shoulder or ledge formed around a smaller second aperture 422. The first fluid container 410 may have a matching first aperture 412 of the same size and may be otherwise mated together with the second fluid container 420 as described above. Without being bound by any theory, the shoulder or ledge formed around the first and second apertures 412, 422 may provide additional structural strength to counter lateral forces exerted by a large volume of liquid stored in the tank components 410, 420.

In embodiments where the first and second apertures 412, 422 have an area less than the entire faces of the first and second fluid containers 410, 420 upon which the first and second apertures 412, 422 are respectively located, the required length of the first and second sealing components 510, 520 will be reduced, facilitating manufacture of the first and second sealing components 510, 520.

In embodiments, the first and second apertures 412, 422 may be of any shape, including an oval or circular opening. It will be appreciated, however, that regardless of shape, it is advantageous for first and second apertures 412, 422 to be sufficiently large so that cleaning of the tanks is facilitated and safety concerns caused by manways are mitigated.

Fluid Containers

The first and second fluid containers 410, 420 may be virtually any shape or size. For example, the first and second fluid containers 410, 420 may be rectangular prisms or boxes, where the dimensions are approximately the maximum legal load that can be transported on the roadways or railways to where they will be used. Alternatively, the dimensions of the first and second fluid containers 410, 420 may be determined by the cargo hold of an aircraft, or the maximum load of a transport helicopter, if designed for transport by air.

In an embodiment, the dimensions of the first and second fluid containers 410, 420 are of a length, width and height within the maximum legal load that can be transported on highways or railways without special permit or restrictions. For example, the first fluid container 410 and second fluid container 420 may each be approximately 12 feet wide by 12 feet high by 55 feet long. Each of the first and second fluid containers 410, 420 would thus be an appropriate size load for roadways in Western Canada. With these dimensions, the stackable fluid storage tank 430 holds a volume of approximately 2800 barrels, thereby replacing seven standard 400 barrel tanks. The footprint of one such stackable fluid storage tank 430 is approximately one half of that required for the seven standard tanks that it can replace. Furthermore, the stackable fluid storage tank 430 requires fewer truckloads to move to a site compared to standard 400 barrel tanks.

In an embodiment, the first and second fluid containers 410, 420 may also be ribbed or corrugated in order to provide additional structural strength. Optionally, first and second fluid containers 410, 420 may also be reinforced with rods or wires 440 anchored to each wall, as shown by way of example in FIG. 9. A plurality of such rods or wires 440 spaced over the length of side walls of the first and second fluid containers 410, 420 may mitigate deformation of the first and second fluid containers 410, 420.

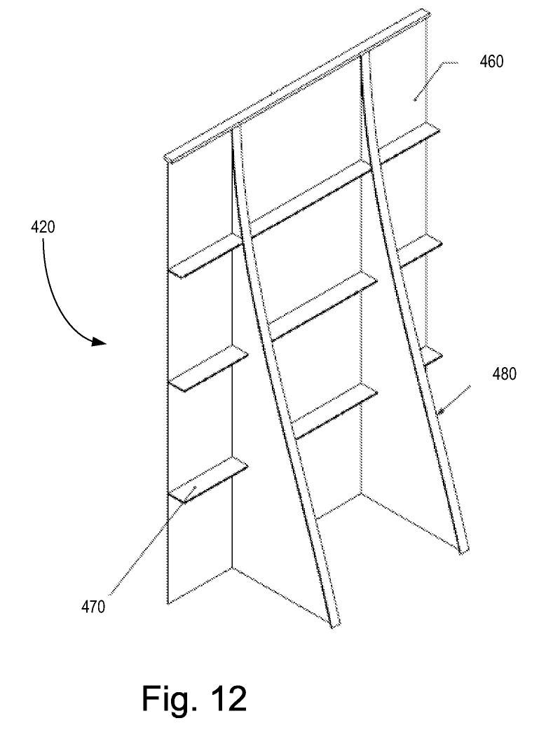

FIG. 12 is a perspective view of wall stiffeners 470 for strengthening wall sheeting 460 of the stackable fluid storage tank 430. The wall stiffeners 470 may be fastened to the wall sheeting 460, for example by welding or other fastening means. Wall supports 480 may be used to strengthen the wall sheeting 460 in a vertical direction. The wall supports 480 are shaped to counter the lateral forces exerted by a large volume of liquid by a sufficient safety margin (e.g. a factor of 3:1).

A suitable construction material for the first and second fluid containers 410, 420 is carbon steel, but the first and second fluid containers 410, 420 can be constructed of any rigid material capable of withstanding the hydraulic loads that will be placed on the faces of the assembled stackable fluid storage tank 430 when filled with fluid.

While not shown, it is understood by one skilled in the art that the first fluid container 410 or the second container 420 or the third fluid container 450 or combinations thereof may include appurtenances including, but not limited to, connections for piping and equipment. Such piping and equipment includes, for example, an inlet, outlet, vent, ingress/egress port, and instrumentation connections.

Modular Components

In an embodiment, the stackable fluid storage tank 430 may be manufactured in modular components for transport to and assembly on a remote site. For example, the modular components may be substantially flat and may be assembled with a lifting device and welding equipment.

Examples Only

In the preceding description, for purposes of explanation, numerous details are set forth in order to provide a thorough understanding of the embodiments. However, it will be apparent to one skilled in the art that these specific details are not required.

The above-described embodiments are examples only. Alterations, modifications and variations can be effected to the particular embodiments by those of skill in the art without departing from the scope, which is defined solely by the claims appended hereto.

What is claimed is:

1. A stackable fluid storage tank comprising:
a first fluid container comprising:
a first body for containing fluid;
a first aperture defined by the first body, the first aperture providing fluid communication with an interior of the first body;
a first seal component extending from the first body around the first aperture; and
a first rigid seal tongue extending from the first seal component; and
a second fluid container comprising:
a second body for containing fluid;
a second aperture defined by the second body, the second aperture providing fluid communication with an interior of the second body;
a second seal component extending from the second body around the second aperture; and
a first seal groove defined by the second seal component and extending along the second seal component;
wherein:
the first aperture is in fluid communication with the second aperture when the first fluid container is mated with the second fluid container for providing fluid communication between the first and second fluid containers; and
the first rigid seal tongue is sized to be received within the first seal groove for providing a fluid-tight seal between the first and second fluid containers around the first and second apertures when the first fluid container is mated with the second fluid container.

2. The stackable fluid storage tank of claim 1 wherein
the first rigid seal tongue has a first cross-section in the shape of a first trapezoid, the first cross-section having a first wide base proximate the first body, a first narrow base distal the first body, and a pair of first legs between the first wide base and the first narrow base; and
the first seal groove has a second cross-section in the shape of a second trapezoid, the second cross-section having a second narrow base proximate the second body, a second wide base distal the second body, the second wide base defining a mouth of the first seal groove, and a pair of second legs between the second narrow base and the second wide base.

3. The stackable fluid storage tank of claim 2 wherein the first trapezoid is a first isosceles trapezoid and each of the first legs forms a first angle with the first narrow base, and wherein the second trapezoid is a second isosceles trapezoid and each of the second legs forms a second angle with the second narrow base.

4. The stackable fluid storage tank of claim 3 wherein the first angle is larger than the second angle to facilitate providing the fluid-tight seal.

5. The stackable fluid storage tank of claim 4 wherein the first angle is larger than the second angle by between about 1 degree and about 5 degrees.

6. The stackable fluid storage tank of claim 5 wherein the first angle is between about 116 degrees and about 125 degrees, and the second angle is between about 115 degrees and about 120 degrees.

7. The stackable fluid storage tank of claim 3 wherein the first angle is smaller than the second angle.

8. The stackable fluid storage tank of claim 7 wherein the first angle is smaller than the second angle by between about 1 degree and about 5 degrees.

9. The stackable fluid storage tank of claim 8 wherein the first angle is between about 110 degrees and about 119 degrees, and the second angle is between about 115 degrees and about 120 degrees.

10. The stackable fluid storage tank of claim 3 wherein the first angle is substantially equal to the second angle and the first narrow base, first legs, second narrow base, and second legs are sized to facilitate complete nesting of the first rigid seal tongue in the first seal groove.

11. The stackable fluid storage tank of claim 1 further comprising:
a third fluid container comprising:
a third body for containing fluid;
a third aperture defined by the third body, the third aperture providing fluid communication with an interior of the third body;
a third seal component extending from the third body around the third aperture; and
a second rigid seal tongue extending from the third seal component;
the first fluid container further comprising:
a fourth aperture defined by the first body and opposed from the first aperture, the fourth aperture providing fluid communication with the interior of the first body;
a fourth seal component extending from the first body around the fourth aperture; and
a second seal groove defined by the fourth seal component and extending along the fourth seal component;
wherein:
the fourth aperture is in fluid communication with the third aperture when the first fluid container is mated with the third fluid container for providing fluid communication between the first and third fluid containers; and
the second rigid seal tongue is sized to be received within the second seal groove for providing a fluid-tight seal between the first and third fluid containers around the fourth and third apertures when the first fluid container is mated with the third fluid container.

12. The stackable fluid storage tank of claim 1 further comprising:
a third fluid container comprising:
a third body for containing fluid;
a third aperture defined by the third body, the third aperture providing fluid communication with an interior of the third body;
a third seal component extending from the third body around the third aperture; and
a second seal groove defined by the third seal component and extending along the third seal component;
the first fluid container further comprising:
a fourth aperture defined by the first body and opposed from the first aperture, the fourth aperture providing fluid communication with the interior of the first body;
a fourth seal component extending from the first body around the fourth aperture; and
a second rigid seal tongue extending from the fourth seal component;
wherein:
the fourth aperture is in fluid communication with the third aperture when the first fluid container is mated with the third fluid container for providing fluid communication between the first and third fluid containers; and
the second rigid seal tongue is sized to be received within the second seal groove for providing a fluid-tight seal between the first and third fluid containers around the fourth and third apertures when the first fluid container is mated with the third fluid container.

13. The stackable fluid storage tank of claim 1 further comprising:
a third fluid container comprising:
a third body for containing fluid;
a third aperture defined by the third body, the third aperture providing fluid communication with an interior of the third body;
a third seal component extending from the third body around the third aperture; and
a second rigid seal tongue extending from the third seal component;
the second fluid container further comprising:
a fourth aperture defined by the second body and opposed from the second aperture, the fourth aperture providing fluid communication with the interior of the second body;
a fourth seal component extending from the second body around the fourth aperture; and
a second seal groove defined by the fourth seal component and extending along the fourth seal component;
wherein:
the fourth aperture is in fluid communication with the third aperture when the second fluid container is mated with the third fluid container for providing fluid communication between the second and third fluid containers; and
the second rigid seal tongue is sized to be received within the second seal groove for providing a fluid-tight seal between the second and third fluid containers around the fourth and third apertures when the second fluid container is mated with the third fluid container.

14. The stackable fluid storage tank of claim 1 wherein the first aperture is substantially the entire area of a first face of the first tank and the second aperture is substantially the entire area of a second face of the second tank.

15. The stackable fluid storage tank of claim 1 wherein the first fluid container is substantially coextensive with the second fluid container when the first fluid container is mated with the second fluid container.

16. The stackable fluid storage tank of claim 1 wherein the fluid-tight seal is a metal-to-metal seal.

17. The stackable fluid storage tank of claim 1 further comprising retainers for retaining the first and second tank components in place when the first and second tank components are mated.

18. The stackable fluid storage tank of claim 1 further comprising a first hinge component extending from the first body and a second hinge component extending from the second body, the first and second hinge components combining as a hinge between the first and second fluid containers when the first and second fluid tanks are mated.

19. A sealing system for providing a fluid-tight seal between a pair of fluid containers, the sealing system comprising:
a first elongate member defining a first elongate attachment surface and an opposed first elongate seal surface, the first elongate member comprising a first seal component extending from the first elongate seal surface and a rigid seal tongue extending from the first seal component, wherein the rigid seal tongue has a first cross-section in the shape of a first trapezoid, the first cross-section having a first wide base proximate the first elongate seal surface, a first narrow base distal the first elongate seal surface, and a pair of first legs between the first wide base and the first narrow base; and
a second elongate member defining a second attachment surface and an opposed second seal surface, the second elongate member comprising a second seal component extending from the second seal surface, the second seal component defining a seal groove extending along the second seal component, wherein the seal groove has a second cross-section in the shape of a second trapezoid, the second cross-section having a second narrow base proximate the second seal surface, a second wide base distal the second seal surface, the second wide base defining a mouth of the seal groove, and a pair of second legs between the second narrow base and the second wide base;
wherein:
the first and second attachment surfaces are for attaching to the fluid containers; and
the rigid seal tongue is sized to be received within the seal groove for providing a fluid-tight seal between the fluid containers when the first and second elongate members are attached to the fluid containers and when the fluid containers are mated with each other.

20. The sealing system of claim 19 wherein the first trapezoid is a first isosceles trapezoid and each of the first legs forms a first angle with the first narrow base, and wherein the second trapezoid is a second isosceles trapezoid and each of the second legs forms a second angle with the second narrow base.

21. The sealing system of claim 20 wherein the first angle is larger than the second angle to facilitate providing the fluid-tight seal.

22. The sealing system of claim 21 wherein the first angle is larger than the second angle by between about 1 degree and about 5 degrees.

23. The sealing system of claim 22 wherein the first angle is between about 116 degrees and about 125 degrees, and the second angle is between about 115 degrees and about 120 degrees.

24. The sealing system of claim 20 wherein the first angle is smaller than the second angle.

25. The sealing system of claim 24 wherein the first angle is smaller than the second angle by between about 1 degree and about 5 degrees.

26. The sealing system of claim 25 wherein the first angle is between about 110 degrees and about 119 degrees, and the second angle is between about 115 degrees and about 120 degrees.

27. A stackable fluid storage tank comprising:
a first fluid container comprising:
a first body for containing fluid;
a first aperture defined by the first body, the first aperture providing fluid communication with an interior of the first body;
a first seal component extending from the first body around the first aperture; and
a rigid seal tongue extending from the first seal component;
wherein the rigid seal tongue has a first cross-section in the shape of a first trapezoid, the first cross-section having a first wide base proximate the first body, a first narrow base distal the first body, and a pair of first legs between the first wide base and the first narrow base, each of the first legs forming a first angle with the first narrow base; and
a second fluid container comprising:
a second body for containing fluid;
a second aperture defined by the second body, the second aperture providing fluid communication with an interior of the second body;
a second seal component extending from the second body around the second aperture; and
a seal groove defined by the second seal component and extending along the second seal component;
wherein the seal groove has a second cross-section in the shape of a second trapezoid, the second cross-section having a second narrow base proximate the second body, a second wide base distal the second body, the second wide base defining a mouth of the seal groove, and a pair of second legs between the second narrow base and the second wide base, each of the second legs forming a second angle with the second narrow base;
wherein:
the first aperture is substantially coextensive with the second aperture when the first fluid container is mated with the second fluid container for providing fluid communication between the first and second fluid containers;
the rigid seal tongue is sized to be received within the seal groove for providing a fluid-tight seal between the first and second fluid containers around the first and second apertures when the first fluid container is mated with the second fluid container; and
the first angle is larger than the second angle to facilitate providing the fluid-tight seal.

28. The stackable fluid storage tank of claim 27 wherein the first larger is smaller than the second angle by between about 1 degree and about 5 degrees.

29. The stackable fluid storage tank of claim 28 wherein the first angle is between about 116 degrees and about 125 degrees, and the second angle is between about 115 degrees and about 120 degrees.

30. The stackable fluid storage tank of claim 27 wherein the first aperture is substantially the entire area of a first face of the first tank and the second aperture is substantially the entire area of a second face of the second tank.
